(19) United States
(12) Patent Application Publication
(10) Pub. No.: US 2020/0191815 A1
(43) Pub. Date: Jun. 18, 2020

(54) SWAPABLE REAGENT MODULES

(71) Applicant: HEWLETT-PACKARD DEVELOPMENT COMPANY, L.P., SPRING, TX (US)

(72) Inventors: Dennis R. Esterberg, Corvallis, OR (US); Craig Olbrich, Corvallis, OR (US); Christie Dudenhoefer, Corvallis, OR (US); Diane R. Hammerstad, Corvallis, OR (US); Heather B. Louderback, Corvallis, OR (US); Suzanne Mirashrafi, Corvallis, OR (US)

(73) Assignee: HEWLETT-PACKARD DEVELOPMENT COMPANY, L.P., SPRING, TX (US)

(21) Appl. No.: 16/603,181

(22) PCT Filed: Jul. 18, 2017
(86) PCT No.: PCT/US2017/042575

§ 371 Date: Oct. 4, 2019

(51) Int. Cl. G01N 35/10; B01L 3/00

(52) U.S. Cl. CPC G01N 35/1002; B01L 3/527; G01N 35/1065; G01N 2035/00049; B01L 2200/141; B01L 2200/16; B01L 2200/028

(57) ABSTRACT

A reagent dispensing system, in an example, may include a processing device, a data storage device coupled to the processing device, a plurality of swappable reagent modules, each swappable reagent module comprising a plurality of reagent dispensing cartridges, and a module frame coupling the reagent cartridges to one another.

### BACKGROUND

The life sciences research and associated diagnostic industries use a number of reagents and patient samples to perform testing and diagnostics of illnesses. These testing and diagnostic processes may be completed using human interaction with hand tools.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a reagent dispensing system according to an example of the principles described herein.

FIG. 2 is a block diagram of a reagent dispensing system according to an example of the principles described herein.

FIG. 3 is a block diagram of a reagent module according to an example of the principles described herein.

FIG. 4 is a block diagram of a computer program product according to an example of the principles described herein.

FIG. 5 is a block diagram of a method for operating a reagent dispensing system according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Human interaction during life science research and diagnostic processes may lead to mistakes in those processes. Such mistakes may decrease the likelihood of scientific breakthroughs and increase the likelihood of misdiagnosis of patient's illnesses. Further, with human interaction, these processes may prove tedious thereby increasing the costs associated with these processes as well as increase the time spent completing the processes. Automation of these processes, however, limits mistakes, time, and costs.

Instruments and tools used in life science research and diagnostic processes have been developed to increase efficiency, decrease costs, and decrease time spent conducting this research or completing diagnosis. However, even with these developments, increased numbers of reagents used to interact with a sample increase the complexity and time of completing those tasks.

The present specification describes a reagent dispensing system that utilizes a number of swappable reagent modules to perform the research and diagnoses described herein. Each of the modules may include a number of reagent dispensing cartridges. Each of the reagent dispensing cartridges may house a different type of reagent. In some examples, each of the swappable reagent modules may include a number of various and differing types of reagents based on the type of research and/or diagnoses being conducted at the time.

The system and devices described herein also provide for the modules to be swapped from an in-line position within a reagent dispensing system to an off-line position and visa-versa. This provides for a reagent dispensing system that may swap out one swappable reagent module for another swappable reagent module based on the type of diagnosis and/or research being conducted in-line. The swappable reagent module may be swapped out by a user or automatically using a module swapping device. In an example, the off-line swappable reagent modules may be maintained in an environmentally controlled condition based on the types of reagents maintained within each of the reagent dispensing cartridges in each of the swappable reagent modules.

The present specification describes a reagent dispensing system including a processing device, a data storage device coupled to the processing device, a plurality of swappable reagent modules, each swappable reagent module comprising a plurality of reagent dispensing cartridges, and a module frame coupling the reagent cartridges to one another.

The present specification further describes reagent module, including a plurality of reagent dispensing cartridges and a module frame coupling the reagent cartridges to one another wherein the volumes of each of dispensable reagents maintained in each of the dispensing cartridges are measured to be depleted approximately simultaneously to minimize waste of the reagents.

The present specification further describes a computer program product for dispensing a reagent, including a computer readable storage medium comprising computer usable program code embodied therewith, the computer usable program code to, when executed by a processor identifying a number of sets of reagent dispensing cartridges housed within a module; and interchanging a first set of dispensing cartridges for a second set of dispensing cartridges based on a type of test protocol conducted wherein the volumes of each of dispensable reagents maintained in each of the dispensing cartridges are measured to be depleted approximately simultaneously to minimize waste of the reagents.

As used in the present specification and in the appended claims, the term “in-line” is meant to be understood as a position of a reagent dispensing cartridge in a reagent dispensing system where the reagent dispensing cartridge can eject an amount of reagent fluid onto a substrate. The in-line position may be directly above the substrate to have reagent fluid ejected onto.

Additionally, as used in the present specification and in the appended claims, the term “off-line” is meant to be understood as a position of a reagent dispensing cartridge in a reagent dispensing system where the reagent dispensing cartridge is stored away for future use or at least not “in-line.” In an example, the off-line position may be located in a module or cartridge storage unit within the reagent dispensing system.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

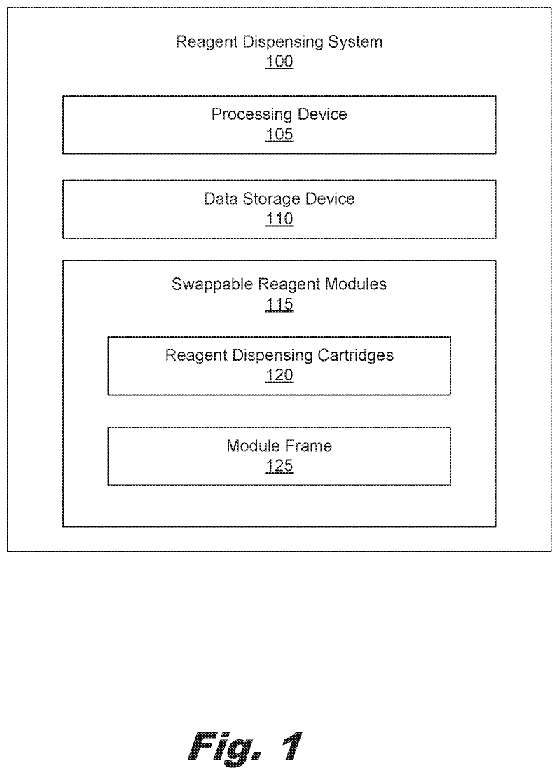

Turning now to the figures, FIG. 1 is a block diagram of a reagent dispensing system (100) according to an example of the principles described herein. The reagent dispensing system (100) includes a processing device (105), a data storage device (110), and a swappable reagent module (115). The swappable reagent module (115) may include a number of reagent dispensing cartridges (120) housed or maintained in a module frame (215).

The reagent dispensing system (100) may be utilized in any scenario where a reagent is to be dispensed in a test protocol. The test protocol may be for any purpose including diagnostics of a test sample or other type of research or diagnosis. For ease of understanding, the reagent dispensing system (100) will be described herein as conducting a diagnosis on a test sample. Additionally, the reagents described herein may include any ejectable material to be dispensed on a substrate such as a test sample or slide.

The reagent dispensing system (100), to achieve its desired functionality, may include a processing device (105) and data storage device (110). In an example, the reagent dispensing system (100) comprises additional various hardware components. Among these hardware components may be a number of peripheral device adapters, and a number of network adapters. These hardware components may be interconnected through the use of a number of busses and/or network connections. In one example, the processing device (105), data storage device (110), peripheral device adapters, and a network adapter may be communicatively coupled via a bus.

The processing device (105) may include the hardware architecture to retrieve executable code from the data storage device (110) and execute the executable code. The executable code may, when executed by the processing device (105), cause the processing device (105) to implement at least the functionality of identifying a number of sets of reagent dispensing cartridges housed within a module and interchanging a first set of dispensing cartridges for a second set of dispensing cartridges based on a type of test protocol conducted, according to the methods of the present specification described herein. In the course of executing code, the processing device (105) may receive input from and provide output to a number of the remaining hardware units.

The data storage device (110) may store data such as executable program code that is executed by the processor (105) or other processing device. As will be discussed, the data storage device (110) may specifically store computer code representing a number of applications or modules that the processor (105) executes to implement at least the functionality described herein.

The data storage device (110) may include various types of memory modules, including volatile and nonvolatile memory. For example, the data storage device (110) may include Random Access Memory (RAM), Read Only Memory (ROM), and Hard Disk Drive (HDD) memory. Many other types of memory may also be utilized, and the present specification contemplates the use of many varying type(s) of memory in the data storage device (110) as may suit a particular application of the principles described herein. In certain examples, different types of memory in the data storage device (102) may be used for different data storage needs. For example, in certain examples the processor (105) may boot from Read Only Memory (ROM), maintain nonvolatile storage in the Hard Disk Drive (HDD) memory, and execute program code stored in Random Access Memory (RAM).

Generally, the data storage device (110) may comprise a computer readable medium, a computer readable storage medium, or a non-transitory computer readable medium, among others. For example, the data storage device (110) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that contains, or stores computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the reagent dispensing system (100) enable the processor (105) to interface with various other hardware elements, external and internal to the reagent dispensing system (100). For example, the peripheral device adapters may provide an interface to input/output devices, such as, for example, display device, a mouse, or a keyboard. The peripheral device adapters may also provide access to other external devices such as an external storage device, a number of network devices such as, for example, servers, switches, and routers, client devices, other types of computing devices, and combinations thereof. The peripheral device adapters may also create an interface between the processor (105) and a display device or other media output devices. The network adapter may provide an interface to other computing devices within, for example, a network, thereby enabling the transmission of data between the reagent dispensing system (100) and other devices located within the network.

The reagent dispensing system (100) may, when executed by the processor (105), display the number of graphical user interfaces (GUIs) on the display device associated with the executable program code representing the number of applications stored on the data storage device (102). The GUIs may display, for example, sample test criteria and various other diagnostics tools used to complete the testing and/or diagnosis described herein. Additionally, via making a number of interactive gestures on the GUIs of the display device, a user may cause the reagent dispensing system (100) to conduct tests and or diagnosis as described herein.

The reagent dispensing system (100) includes a number of swappable reagent modules (115). The swappable reagent modules (115) may comprise a number of reagent dispensing cartridges (120) housed by a module frame (125). In an example, the module frame (125) may house a single reagent dispensing cartridge (120). In this example, the single reagent dispensing cartridge (120) may maintain a single type of reagent fluid used, by the reagent dispensing system (100), microscope slides, test samples, cell-culture dishes such as Petri dishes, paper, and tissue samples, among other substrate surfaces. In this example, the reagent dispensing cartridge (120) may further include a silicon die used to eject, from the reagent dispensing cartridge (120) an amount of reagent as described above. In an example, the single reagent dispensing cartridge (120) may house a plurality of reagents, each reagents ejectable from the single reagent dispensing cartridge (120). In this example, the single reagent dispensing cartridge (120) may include two individual silicon dies used to eject the two different reagents.

In an example, the swappable reagent module (115) may include a module frame (125) housing a plurality of reagent dispensing cartridges (120). In this example, each of the plurality of reagent dispensing cartridges (120) may maintain an amount of reagent fluid. In some examples, the plurality of reagent dispensing cartridges (120) may each dispense, from a silicon die, a different type of reagent fluid. In some examples, a plurality of the reagent dispensing cartridges (120) may contain the same reagent fluid. In some examples, the number and types of reagent fluids maintained in the plurality of reagent dispensing cartridges (120) may be selected based on the type of test and/or diagnosis to be conducted. Thus, each of the swappable reagent modules (115) may be populated with any number of reagent dispensing cartridges (120) based on the type of test and/or diagnosis being conducted by the reagent dispensing system (100).

In an example, the reagent dispensing system (100) may maintain, in a module storage device associated and/or formed within part of the reagent dispensing system (100), a plurality of swappable reagent modules (115). Each of the swappable reagent modules (115) may be used to conduct different types of tests and/or diagnosis based on the types of reagents housed in the reagent dispensing cartridges (120). The swappable reagent modules (115) may be swapped out based on which test and/or diagnosis is to be conducted by the reagent dispensing system (100). Thus, a first swappable reagent module (115) may be removed from an in-line position to an off-line position within a module storage device. In an example, a reagent dispensing cartridge (120) could be removed from an in-line position to an off-line position and a different reagent dispensing cartridge (120) put in its place in-line.

In some examples, the number of reagent dispensing cartridges (120) within the swappable reagent modules (115) may be so grouped so as to provide the reagents used for any particular type of test or diagnosis to be conducted with the reagent dispensing system (100). In some examples, the number of reagent dispensing cartridges (120) could each contain a plurality of individual types of reagents. In this example, the number of reagents used in connection with a particular test and/or diagnosis may exceed the number of reagent dispensing cartridges (120) within the swappable reagent modules (115) in-line. In some examples, the volume of reagents within any given reagent dispensing cartridge (120) may be sized so as to be able to complete a specified number of tests and/or diagnosis. Thus, in some examples, any number of reagent dispensing cartridges (120) may contain any number of different reagents so organized so as to complete a specific test and/or diagnosis a specified number of times.

In an example, the module frames (125) may include mechanical and electrical interconnects used to physically and electrically couple the swappable reagent modules (115) to the reagent dispensing system (100), respectively. The mechanical interconnects may allow each of the swappable reagent modules (115) to be physically maintained either in an in-line or off-line position as described herein. In some example, the mechanical interconnects may lock each of the swappable reagent modules (115) in their respective locations. In an example, each of the swappable reagent modules (115) may include electrical interconnects that allow each of the reagent dispensing cartridges (120) to be electrically connected to the reagent dispensing system (100) through the module frame (125). In an example, the module frame (125) may include a void through which an electrical interconnect defined on each of the reagent dispensing cartridges (120) may be coupled to an electrical interconnect of the reagent dispensing system (100). In these examples, the electrical interconnect may be used as a voltage source for each of the silicon dies of each of the reagent dispensing cartridges (120) in order to allow for the ejection of the reagent fluids as described herein.

In an example, the different reagents maintained within each of the reagent dispensing cartridges (120) may be metered to have a volume such that the use of the reagents causes each of the volumes of reagents to be depleted approximately simultaneously. In some examples, the reagent dispensing cartridges (120) maintain a different volume of reagent based on the consumption ratio between the different reagents to be used during a test protocol. In some of these examples, any amount of reagent fluid left over in any of the reagent dispensing cartridges (120) as one of the reagent dispensing cartridges (120) has been depleted may be up to 5 mL. The measuring of the volumes of each of the reagents within the reagent dispensing cartridges (120) may be done using an electrical interface between the reagent dispensing cartridges (120) and the reagent dispensing system (100). In an example, the volumes of each of the reagents within the reagent dispensing cartridges (120) may be assumed to be a certain volume based on the original amount of reagent and the number of ejections of any specific reagent from the reagent dispensing cartridges (120). In an example, the reagent dispensing system (100) may notify a user of the depletion of any of the reagents. In some examples, the various reagent fluids may be relatively expensive if purchased in mass quantities as compared to other of the reagent fluids. By depleting the reagents approximately simultaneously, waste of the reagents may be reduced. Additionally, by depleting the reagents approximately simultaneously, a set amount of any one of the reagent fluids may be maintained within any one of the reagent dispensing cartridges (120) such that an expiration of any one of the reagents fluids does not occur before the depletion. In an example, the volumes of each of dispensable reagents maintained in each of the reagent dispensing cartridges (120) are measured to be depleted based on a sample test protocol, a test protocol, and/or a diagnosis being conducted.

In an example, the different reagents maintained within each of the reagent dispensing cartridges (120) may be metered to be depleted before a prescribed expiration date of the reagents. In this example, the reagent dispensing system (100) may be made aware of the expiration date either via a user interacting with the reagent dispensing system (100) via a graphical user interface or via an electrical connection between a memory device on each of the reagent dispensing cartridges (120) and the reagent dispensing system (100). In some examples, the reagent dispensing system (100) can detect a new reagent dispensing cartridge (120), be notified as to its contents, and begin a timer for any specific reagent dispensing cartridge (120) that contains perishable reagents therein. At the end of the expiration, the reagent dispensing system (100) may notify a user that the reagent has expired. Other methods of determining the expiration of the reagents within the reagent dispensing cartridges (120) exist and may include optical, electrically encoded systems, among others. The present specification, therefore, contemplates the use of these other methods to determine the expiration of any reagent within the reagent dispensing cartridges (120).

The reagent dispensing system (100) may further include a module swap system. The module swap system may remove a first of the swappable reagent modules (115) from an in-line position to an off-line position. The module swap system may further remove a second of the swappable reagent modules (115) from an off-line position and place it in an in-line position. In an example, the module swap system may include a number of robotic arms to swap the swappable reagent modules (115) as described herein. In an example, the module swap system may include a number of rails to swap the swappable reagent modules (115) as described herein. The module swap system may be any device that may swap the individual swappable reagent modules (115) as described herein. In the examples described herein, the swapping of the first and second modules is done based on the type of test protocol to be or being conducted by the reagent dispensing system (100).

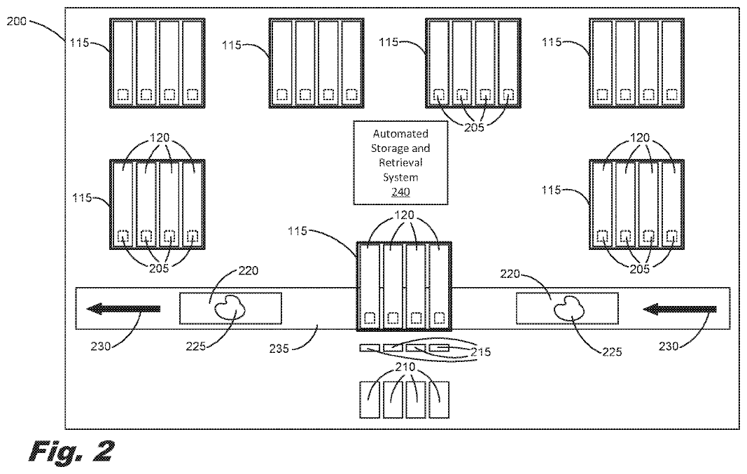

FIG. 2 is a block diagram of a reagent dispensing system (200) according to an example of the principles described herein. In an example, the reagent dispensing system (200) is an automated, computer driven system that dispenses, through a number of reagent dispensing devices, a number of different reagents. The reagents may be any chemical or biological substance that may be used in any chemical reaction such as titrations, combinations, decompositions, single displacements, precipitations, neutralizations, double displacements, combustions, and reductions/oxidations, among other types of chemical or biological reactions. The reagents may be, for example, solutions including nucleic acid; deoxyribonucleic acid (DNA); ribonucleic acid (RNA); small (or short) interfering RNA (siRNA); polymerase chain reaction (PCR) master mix; proteins including, for example, enzymes and antibodies; other biomolecules including, for example, peptides, oligos, and lipids; small molecules, nanoparticles, biocides, cells or other tissue components, histology stains, linker reagents, inhibitors, or other reagents.

In addition to the swappable reagent modules (115) and their respective reagent dispensing cartridges (120), the reagent dispensing system (200) may include additional devices that may be used during the testing and/or diagnosis processes. In an example, the reagent dispensing system (200) may include an in-line wiping station (215) for each of the reagent dispensing cartridges (120) as well as an in-line capping station (210). The wiping station (215) may be used to wipe off a number of silicon dies (205) of each of the reagent dispensing cartridges (120). This process may form part of the reagent dispensing cartridges (120) maintenance process used to maintain the health of the silicon dies (205) of the reagent dispensing cartridges (120). The in-line capping station (210) may further cap each of the silicone dies (205) of the reagent dispensing cartridges (120) when the reagent dispensing cartridges (120) are not currently in use by the reagent dispensing system (200) but are maintained at an in-line location. In these examples, the wiping station (215) and in-line capping station (210) may move toward the swappable reagent modules (115) and the individual reagent dispensing cartridges (120) in order to conduct the maintenance processes as described herein. Both the in-line wiping station (215) and the in-line capping station (210) may move relative to the in-line swappable reagent modules (115) in order to conduct the servicing of the reagent dispensing cartridges (120) as described herein.

Alternatively, each of the swappable reagent modules (115) whether in-line or off-line each may include their respective wiping station (215) and capping stations (210). In an example, the module frame (FIG. 1, 125) of the swappable reagent modules (115) may comprise its own wiping station (215) and capping station (210) mechanically coupled to the module frame (125). This may allow for each swappable reagent modules (115) to be separately maintained without creating cross-contamination of the various reagent fluids of each of the reagent dispensing cartridges (120). Further, the inclusion of the wiping station (215) and capping station (210) with the module frame (FIG. 1, 125) allows the swappable reagent modules (115) to consistently be maintained regardless of whether they are off-line, in-line, or in transit between the two positions.

The reagent dispensing system (200) may further include a conveyance system (235) that conveys a substrate (220) along the direction of the arrows (230) shown in FIG. 2. In an example, the conveyance system (235) may also move opposite of the arrows (230) so as to allow the substrate (220) to pass, in the opposite direction, under the swappable reagent modules (115) and specifically the reagent dispensing cartridges (120). This may allow for any number of coatings of any of the reagents to be applied to a test sample or substrate (220). Additionally, this may allow for time to pass before a second reagent or an additional layer of reagent is applied thereby allowing, in some examples, a reaction to occur on the substrate (220).

The conveyance system (235) may convey any type of substrate (220) onto which a reagent ejected from the reagent dispensing cartridges (120) may be placed. In an example and in the example shown in FIG. 2, the substrate (220) is a microscope slide or other slide that may carry a test sample (225). Other substrates (220) may be used either alone or in combination with a test sample (225) and the present specification contemplates the use of those other substrates (220).

The reagent dispensing system (200) may further include an automated storage and retrieval system (ASRS) (240) may be used to transport the swappable reagent modules (115) to and from the area along the conveyance system (235). The ASRS (240) may include any number of conveyor systems, lift systems, robotic arms, other ASRS systems, and combinations thereof. In another example, a technician may manually exchange the swappable reagent modules (115) by removing them from an off-line location in a module storage device and placing the swappable reagent modules (115) in an in-line position.

FIG. 2 shows the plurality of swappable reagent modules (115) with each of the swappable reagent modules (115) including, in this example, four reagent dispensing cartridges (120). It is to be understood that the number of swappable reagent modules (115) and their respective reagent dispensing cartridges (120) are merely examples and the depicted number of these swappable reagent modules (115) and their respective reagent dispensing cartridges (120) are not meant to be limiting. The swappable reagent modules (115), however, provide for a plurality of sample tests and/or diagnosis to be conducted using the reagent dispensing system (200). As example only, a user may wish to conduct a plurality of different tests implementing any number and/or combination of reagents housed within each of the reagent dispensing cartridges (120). In an example, the reagents housed within each of the reagent dispensing cartridges (120) of a given swappable reagent module (115) may be selected based on a test to be conducted by the reagent dispensing system (200). Thus, a user may be able to select, via a graphical user interface associated with the reagent dispensing system (200) for example, a specific type of test to be conducted on a test sample and the reagent dispensing system (200) may implement that swappable reagent module (115) having those reagent dispensing cartridges (120) that hold the appropriate type and/or amount of reagent fluid for the test. In some examples, specific swappable reagent module (115) used for a specific test may be swapped out with an in-line swappable reagent module (115) in order to conduct that test using the appropriate reagents. In some examples, a plurality of reagent dispensing cartridges (120) maintained in a plurality of swappable reagent modules (115) may hold the same type of reagent but may be grouped with other reagents in order to conduct different types of tests.

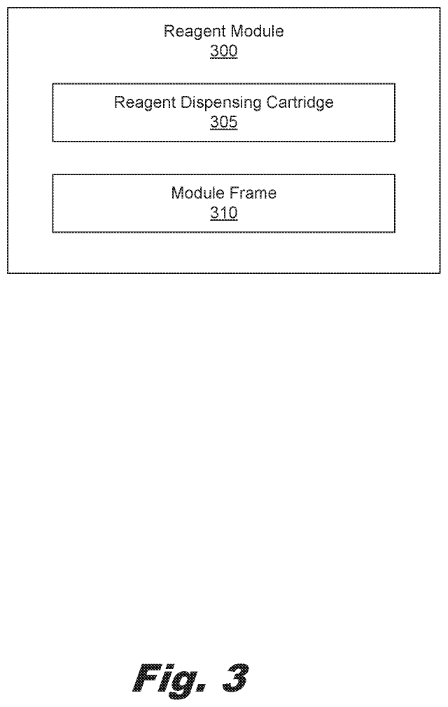

FIG. 3 is a block diagram of a reagent module (300) according to an example of the principles described herein. The reagent module (300) may include a module frame (310) housing a plurality of reagent dispensing cartridges (305). As mentioned previously, any number of reagent dispensing cartridges (120) may be housed within the individual swappable reagent modules (115). The module frame (310) may be formed to selectively fit a varying number of reagent dispensing cartridges (120). In an example, the module frame (310) may be used to house reagent dispensing cartridges (120) of different sizes. Apart from the example shown in FIG. 2, a single first reagent dispensing cartridge (120) may be grouped with a second and third reagent dispensing cartridges (120) that are relatively fluidically smaller than the first reagent dispensing cartridge (120). These three reagent dispensing cartridges (120) may be housed within the module frame (310) as described above. The module frame (310), however, may be so formed so as to alternatively receive a total of four, for example, reagent dispensing cartridges (120).

The reagent dispensing cartridges (120) may each be capable of ejecting either one or a plurality of reagent fluids. In some examples, each of the reagent dispensing cartridges (120) may eject two individual types of reagent fluids amounting to the possibility of eight reagent fluids being ejected from the swappable reagent modules (115), according to the example shown in FIG. 2.

The module frame (310) may be made of a resilient material sufficient to hold in place the reagent dispensing cartridges (120). The module frame (310) may be made of a plastic, metal, or combinations thereof. As described herein, the module frame (310) may have a capping station and/or a wiping station built into the module frame (310). The capping station and wiping station may help to maintain the reagent fluid ejection heads of each of the reagent dispensing cartridges (120). In particular, the capping station may move into place against each of the ejection heads of the reagent dispensing cartridges (120) when the reagent dispensing cartridges (120) are not in use either in-line or off-line. The wiping stations may interact with the reagent fluid ejection heads so as to remove excess reagent fluid or contaminants from off of the reagent fluid ejection heads. Because each module frame (310) includes a wiping station and capping station of its own, a wiping station and capping station may not be provided in-line. Additionally, because each module frame (310) includes a wiping station and capping station of its own, the reagents held within each of the reagent dispensing cartridges (120) will not be contaminated when a common wiping station or capping station is used to wipe or cap all reagent fluid ejection heads.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, a processor of the reagent dispensing system (100, 200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

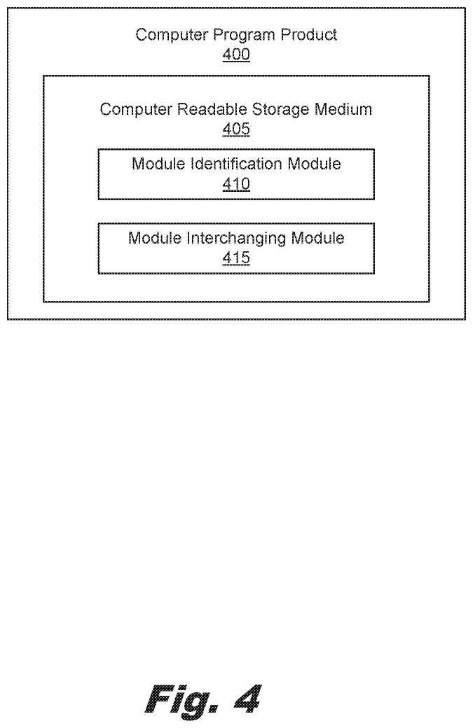

FIG. 4 is a block diagram of a computer program product (400) according to an example of the principles described herein. The computer program product (400) may include computer readable storage medium (405) that embodies certain computer usable program code. Among the computer usable program code is computer usable program code to, when executed by a processor, identify a number of sets of reagent dispensing cartridges housed within a module and interchange a first set of dispensing cartridges for a second set of dispensing cartridges based on a type of test protocol conducted. The processor may form part of the reagent dispensing system (100, 200) as described herein with the computer usable program code maintained on the data storage device (110). A module identification module (410) may identify a number of sets of reagent dispensing cartridges housed within a module. A module interchanging module (415) may interchange a first set of dispensing cartridges maintained in module frame (210) for a second set of dispensing cartridges also maintained in a module frame (210) based on a type of test protocol conducted.

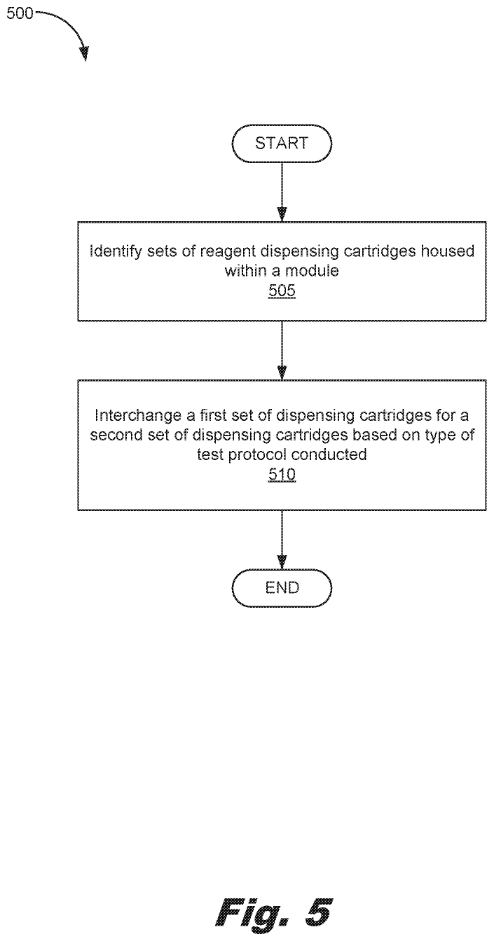

FIG. 5 is a block diagram of a method (500) for operating a reagent dispensing system (100, 200) according to an example of the principles described herein. The method (500) may begin by identifying (505) sets of reagent dispensing cartridges (120) housed within a module frame (210). As described herein, the selection of the types of reagents used, and correspondingly the selection reagent dispensing cartridges (120), may be dependent on the type of test to be conducted. The identification of the type of reagent in any give reagent dispensing cartridge (120) may, in an example, be completed using a barcode system or other type of identification system that allows the reagent dispensing system (100, 200) to know what type of reagent fluid is in each of the reagent dispensing cartridges (120). The identification process may also include identifying a set of reagent fluids maintained within a set of reagent dispensing cartridges (120). This set of reagent dispensing cartridges (120) may be bundled together via use of the module frame (210) described herein. Thus, a module frame (210), in an example, may include an identification, such as a barcode, used to identify a group of different types of reagent fluids. As described herein, this used of identifications may provide for a reagent dispensing system (100, 200) that can readily determine the types of reagent fluids of a swappable reagent module (115), select it, and place it in an in-line position within the reagent dispensing system (100, 200).

The method (500) may continue with interchanging a first set of reagent dispensing cartridges (120) for a second set of reagent dispensing cartridges (120) based on a type of test protocol conducted. The first set of reagent dispensing cartridges (120) may not include a reagent fluid to be used for a specific test being carried out by the reagent dispensing system (100, 200). Because the reagent dispensing system (100, 200) knows which swappable reagent module (115) is currently in an in-line position, the reagent dispensing system (100, 200) may search for an appropriate swappable reagent module (115) and make the exchange according to the test protocol to be carried out by the reagent dispensing system (100, 200).

The specification and figures describe a test protocol reagent module that includes a plurality of reagent dispensing cartridges grouped together within the module. The grouping of the individual reagent dispensing cartridges is based on the type of test to be conducted by the reagent dispensing system described herein. Each reagent dispensing cartridge contains at least one reagent used for the test to be conducted by the reagent dispensing system. Additionally, the grouping of the reagent dispensing cartridges is based on a specific type of test to be conducted. Those swappable reagent modules not being used for the test may be maintained off-line and within a module storage device of the reagent dispensing system. This reagent dispensing system allows a user to select a type of test to be conducted with the reagent dispensing system swapping a swappable reagent module for another swappable reagent module to fit a specific test protocol profile.

The preceding description has been presented to illustrate and describe examples of the principles described. This description is not intended to be exhaustive or to limit these principles to any precise form disclosed. Many modifications and variations are possible in light of the above teaching.

What is claimed is:

1. A reagent dispensing system, comprising:
a processing device;
a data storage device coupled to the processing device;
a plurality of swappable reagent modules, each swappable reagent module comprising:
a plurality of reagent dispensing cartridges; and
a module frame coupling the reagent cartridges to one another.

2. The reagent dispensing system of claim 1, wherein the volumes of each of dispensable reagents maintained in each of the dispensing cartridges are measured to be depleted approximately simultaneously based on a minimization of waste of the reagents.

3. The reagent dispensing system of claim 2, wherein the volumes of each of dispensable reagents maintained in each of the dispensing cartridges are measured to be depleted based on a sample test protocol.

4. The reagent dispensing system of claim 2, wherein the volumes of each of dispensable reagents maintained in each of the dispensing cartridges are measured to expire approximately simultaneously.

5. The reagent dispensing system of claim 1, comprising a module swap system to exchange a first module for a second module based on the type of test protocol being conducted by the reagent dispensing system.

6. The reagent dispensing system of claim 5, wherein swapping of the first and second modules is done based on the type of test protocol conducted.

7. The reagent dispensing system of claim 6, wherein the reagents maintained in each of the dispensing cartridges of the each of the first and second modules are selected based on the type of test protocol conducted.

8. A reagent module, comprising:
a plurality of reagent dispensing cartridges; and
a module frame interfacing with the plurality of reagent dispensing cartridges;
wherein a volume of a dispensable reagent maintained in the plurality of dispensing cartridges is measured to be depleted approximately simultaneously to minimize waste of the reagents.

9. The reagent module of claim 8, wherein the volumes of each of dispensable reagents maintained in each of the dispensing cartridges are measured to be depleted based on a sample test protocol.

10. The reagent module of claim 8, wherein the volumes of each of dispensable reagents maintained in each of the dispensing cartridges are measured to expire approximately simultaneously.

11. The reagent module of claim 8, wherein the plurality of reagent dispensing cartridges are selected to be held within the reagent module based on a test protocol being conducted.

12. The reagent module of claim 8, wherein a number of a plurality of reagent dispensing cartridges maintains a different volume of reagent based on the consumption ratio between the different reagents during a test protocol.

13. A computer program product for dispensing a reagent, comprising:
a computer readable storage medium comprising computer usable program code embodied therewith, the computer usable program code to, when executed by a processor:
identify a number of sets of reagent dispensing cartridges housed within a module; and
interchange a first set of dispensing cartridges for a second set of dispensing cartridges based on a type of test protocol conducted;
wherein the volumes of each of dispensable reagents maintained in each of the dispensing cartridges are measured to be depleted approximately simultaneously to minimize waste of the reagents.

14. The computer program product of claim 13, wherein the volumes of each of dispensable reagents maintained in each of the dispensing cartridges are measured to be depleted based on a sample test protocol.

15. The computer program product of claim 13, wherein the volumes of each of dispensable reagents maintained in each of the dispensing cartridges are measured to expire approximately simultaneously.
